(19) United States
(12) Patent Application Publication
(10) Pub. No.: US 2025/0018746 A1
(43) Pub. Date: Jan. 16, 2025

(54) PNEUMATIC VEHICLE TYRE WITH A BELT BANDAGE

(71) Applicant: Continental Reifen Deutschland GmbH, Hannover (DE)

(72) Inventor: Wolfgang Reese, Peine (DE)

(73) Assignee: Continental Reifen Deutschland GmbH, Hannover, OT (DE)

(21) Appl. No.: 18/711,473

(22) PCT Filed: Sep. 9, 2022
(86) PCT No.: PCT/DE2022/200213

§ 371 Date: May 17, 2024

(30) Foreign Application Priority Data
Nov. 19, 2021 (DE) 10 2021 213 031.3

(51) Int. Cl. B60C 9/20; B60C 9/00; D07B 1/02

(52) U.S. Cl. CPC B60C 9/2003; B60C 9/0042; D07B 1/02; B60C 2009/2077; B60C 2009/208; B60C 2009/2083; B60C 2009/2093; B60C 2200/04; D07B 2201/1044; D07B 2201/2009; D07B 2205/2046; D07B 2401/2005

(57) ABSTRACT

A pneumatic vehicle tire having a carcass with textile carcass strength elements, a belt arranged radially outside the carcass, and a belt bandage ply of a belt bandage arranged radially outside the belt, wherein the belt bandage ply has textile cords as strength elements, which are arranged substantially parallel to one another and are embedded in elastomeric material, wherein the cords each have precisely two yarns, wherein the two yarns are yarns of polyamide 6.6 (PA 6.6), which have the same linear density and are end-twisted together to form the cord.

### BRIEF SUMMARY

The invention relates to a pneumatic vehicle tire having a carcass, in particular of radial design, with textile carcass strength elements, a belt arranged radially outside the carcass, and a belt bandage ply of a belt bandage arranged radially outside the belt, wherein the belt bandage ply has textile cords as strength elements, which are arranged substantially parallel to one another and are embedded in elastomeric material, wherein the cords each have precisely two yarns, wherein the two yarns are yarns of polyamide 6.6 (PA 6.6), which have the same linear density and are end-twisted together to form the cord.

Pneumatic vehicle tires with strength element plies having strength elements are well known. A carcass, in particular of radial design, with textile strength elements, is thus known for pneumatic vehicle tires. In the case of a carcass of radial design, the strength elements of the carcass enclose an angle of a maximum of 10°, in particular a maximum of 6°, with the radial direction rR of the tire in the region of side walls of the tire. The belt may have two strength element plies, the strength elements of which have opposite slope directions.

It is also known for pneumatic vehicle tires to use a belt bandage which has one or more belt bandage plies and at least covers the belt edges, wherein the one or more belt bandage plies contain strength elements which run parallel and substantially in the circumferential direction and are in the form of cords embedded in the rubber. This belt bandage has the purpose, in particular in high-speed use, of preventing the tire from undergoing an elevation due to the centrifugal forces arising in operation.

During tire production, the belt bandage is applied in the form of plies, strips or individual cords with strength elements which are embedded in an unvulcanized rubber mixture and are wound or coiled onto the belt. The strength elements are embedded in rubber by a sheet of substantially parallel thread-shaped strength elements, which are generally pretreated thermally and/or with impregnation for better adherence to the embedding rubber in a manner known to a person skilled in the art, passing in the longitudinal direction through a calender or an extruder for sheathing with the rubber mixture.

The cords of the belt bandage are intended to allow sufficient elevation in shaping and in the vulcanization mold during tire production in order that the tire may be precisely formed, and are intended to ensure, after the tire is finished, good high-speed capability, i.e. good dimensional stability, in operation. In order to meet these requirements, the cords should be extendable with moderate force up to an elongation of about 3 to 4% and require a very much higher force to be extendable to a higher elongation.

It is known to use cords consisting of one or two yarns made of PA 6.6 as a material for the strength elements of the belt bandage ply of the belt bandage, since PA 6.6 has a shrinkage behavior which is advantageous for the high-speed capability and good fatigue resistance in respect of alternating tension and compression loads on and next to the belt edge. For example, the use of a cord of the structure PA 6.6 1400 dtex×2 is known and conventional.

A disadvantage of PA 6.6, however, is the low tangent modulus, which limits the high-speed capability. To improve the tangent modulus, it is known to use hybrid cords consisting of a yarn made of PA 6.6 and a yarn made of aramid. Cords of this type are, however, expensive and have a disadvantageous fatigue resistance, more sensitive adhesion properties, and lower shrinkage forces.

It is therefore the object to provide a pneumatic vehicle tire, in particular for a passenger car, which has a further improvement in the high-speed capability.

This is achieved by the fact that the cords at an elongation of 4% have a tangent modulus of 9.3 N/% to 14 N/%, preferably of 9.5 N/% to 13 N/%, particularly preferably of 11 N/% to 12.5 N/%.

The tangent modulus of a cord at a given elongation corresponds to the gradient of the force-elongation curve at the respective elongation of the cord, wherein the force-elongation curve is determined according to ASTM D 885/ASTM D 885 M. The force-elongation curve may be determined at the elongated and dipped cord which is provided with an adhesion promoter before being introduced into the elastomeric material.

Surprisingly, it has been shown that such a pneumatic vehicle tire has a further improvement in the high-speed capability because of the increased tangent modulus of the cords of the belt bandage ply of the belt bandage.

The cord consisting of two yarns made of PA 6.6 also has shrinkage properties which are advantageous for the high-speed capability and good fatigue resistance. The comparatively high tangent modulus of the cord at 4% elongation of at least 9.3 N/%, preferably of at least 9.5 N/%, particularly preferably of 11 N/%, advantageously permits high circumferential forces of the tire, especially for use at high speeds. The high centrifugal forces occurring in high-speed use can thus be better focused and the high-speed capability is improved. The high tangent modulus causes a reduction in the dynamic growth and a reduction in vibration in high-speed use. A limitation of the tangent modulus of the cord to a maximum of 14 N/% ensures a sufficient elevation with moderate forces during the tire building process.

Compared to the use of a hybrid cord having aramid, the tire equipped with the cord made of PA 6.6 is favorable in material costs. Furthermore, the cord made of PA 6.6 has an improved fatigue resistance, higher shrinkage forces and easier processability than the hybrid cord having aramid.

With its good shrinkage properties and its increased tangent modulus, the belt bandage ply of the belt bandage is excellently suited to counteract the centrifugal forces occurring in high-speed use, to hold the belt edges down and thus to form a round contour of the tire, which is important for the high speed.

The cords of the belt bandage ply of the belt bandage are arranged, as is customary for strength elements of the belt bandage ply, at an angle between 0° and 5° to the circumferential direction of the tire, in particular are wound or coiled along an axial width of the tire.

An advantageous embodiment is provided in that the belt bandage ply at 4% elongation of the belt bandage ply in the direction of extent of the cords has a tangent modulus per cm width of the belt bandage ply of 8300 N/cm to 14000 N/cm, preferably of 8500 N/cm to 13000 N/cm.

The tangent modulus per cm width of the belt bandage ply corresponds to the tangent modulus of the cords times the number of cords per cm width of the belt bandage ply. It has been shown that a pneumatic vehicle tire with such a belt bandage ply of the belt bandage has a particularly good high-speed capability with at the same time sufficient elevation during the tire building process.

An advantageous embodiment is characterized in that the cords have the structure PA 6.6 1880 dtex×2.

Thus, two yarns made of PA 6.6 with the linear density of 1880 dtex are end-twisted together to form the cord. Measurements of the force-elongation curve of such a cord have shown that, in comparison to a cord of the structure PA 6.6 1400 dtex×2, such a cord already has a tangent modulus which is advantageously increased for high-speed capability, despite an only slight increase in the diameter.

For example, a cord of the structure PA 6.6 1880 dtex×2 has a tangent modulus of 11.8 N/%, whereas the corresponding reference cord of the structure PA 6.6 1400 dtex×2 has a tangent modulus, which is lower by 2.8 N/%, of only 9.0 N/%, in each case measured at an elongation of 4%. The cord and the reference cord each have an identical twist factor of 150.

The thicker cord also has higher shrinkage forces with the increased use of PA 6.6 material, which is further advantageous for the high-speed capability.

A pneumatic vehicle tire having such a belt bandage ply of the belt bandage thus has improved high-speed capability with an only slightly increased rolling resistance. At the same time, the tire is favorable in its use of materials and production.

An advantageous embodiment is characterized in that the cords are arranged with a thread density of 80 epdm to 100 epdm, preferably of 85 epdm to 95 epdm, particularly preferably with a thread density of 90 epdm.

Surprisingly, it has been shown that such a belt bandage ply with good shrinkage properties has an excellent tangent modulus per cm width of the belt bandage ply.

An advantageous embodiment is provided in that the cords have the structure PA 6.6 1880 dtex×2 and are arranged with a thread density of 80 epdm to 100 epdm, preferably of 85 epdm to 95 epdm, particularly preferably with a thread density of 90 epdm.

Surprisingly, it has been shown that a belt bandage ply F1 according to the invention, which has cords of the structure 1880 dtex×2 in an arrangement of the cords with a thread density of 90 epdm, has a tangent modulus at 4% elongation of the belt bandage ply in the direction of extent of the cords that is higher by more than 2500 N/cm than the corresponding tangent modulus of a reference ply R1, which has reference cords of the structure 1400 dtex×2, which are also arranged with a thread density of 90 epdm. The belt bandage ply F1 according to the invention has a tangent modulus per cm width of 10580 N/cm at an elongation of 4%. The cords and the reference cords each have an identical twist factor of 150.

A pneumatic vehicle tire having such a belt bandage ply F1 according to the invention in the belt bandage has excellent high-speed capability. The thickness and use of materials in the belt bandage ply are only slightly increased, and therefore the rolling resistance is not significantly increased.

Furthermore, it has been shown in the comparison of the two belt bandage plies F1 and R1 that, at an elongation of 19% of the respective ply, the strength of said belt bandage ply F1 according to the invention is increased by 526 N/cm compared to the belt bandage ply R1. At the same time, the energy at break of the belt bandage ply F1 according to the invention is increased in contrast to the belt bandage ply R1, which results in advantages in the plunger.

Each yarn in the belt bandage ply can be twisted in the S or in the Z direction. An advantageous embodiment is provided in that the two yarns of the cord have the same direction of rotation. They are therefore either both twisted in the S and/or in the Z direction. According to the invention, the two yarns of the cord are end-twisted together in the S or in the Z direction to form the cord. Preferably, the direction of rotation to form the cord is opposed to the direction of rotation of the yarns. This reduces internal stresses in the cord.

In order to ensure reliable adhesion of textile cords to the rubber, it is advantageous that the cords are provided with an adhesive impregnation to ensure the adhesion of the cords to the rubber. For example, this adhesive impregnation can be undertaken with an RFL dip in the single- or double-bath process. However, it is also possible to achieve impregnation by using any of the other processes and adhesives known to a person skilled in the art.

An advantageous embodiment is characterized in that the twist factor of the cord is 120 to 220, preferably 130 to 200, particularly preferably 140 to 180.

An advantageous embodiment is provided in that the twist factor of the cord lies in a range of 120 to 220, preferably of 130 to 200, particularly preferably of 140 to 180, wherein the twist factor is defined as twist factor=twist [t/m]×(linear density [dtex]/10000)^{1/2}.

The twist factor is a measure of the end twisting per meter of the cord, relative to the linear density of the cord. This twist factor represents an advantageous compromise between fatigue resistance and strength. A lower twist factor would be detrimental with regard to the fatigue resistance, a higher twist factor would mean a lower strength of the cord.

An advantageous embodiment is characterized in that at least one cord is arranged over the entire axial extent of the belt and beyond.

Thus, the belt bandage ply having the at least one cord is a continuous belt bandage ply, which extends over the entire axial extent of the belt and covers the belt edges. This makes it possible to deploy the advantageous effect of the high tangent modulus over the entire axial extent of the belt including the belt edges.

Pneumatic vehicle tires for a passenger car, vans or light-duty vehicles usually have a structure with a belt having at least two strength element plies and a carcass with textile strength elements. The belt is covered by a single- or multi-ply belt bandage, at least in the region of the belt edges. The carcass has textile strength elements that can enclose an angle of a maximum of 6° with the radial direction rR of the tire in the region of sidewalls.

An advantageous embodiment is characterized in that the vehicle is a passenger car.

The high-speed capability is of particular relevance and advantage for tires of passenger cars.

An advantageous embodiment is characterized in that the vehicle is a light-duty vehicle or a van.

All of the embodiments of the pneumatic vehicle tire according to the invention reproduced in this description are examples of the configuration of the invention and should be seen as non-limiting. Accordingly, further embodiments of the invention, which are the subject matter of the invention, unless explicitly explained otherwise in the description, are also provided by individual features or a plurality of features of one embodiment alone or by the combination of the features of different embodiments. Furthermore, combinations of preferred and particularly preferred embodiments can also be combined with one another.

### BRIEF DESCRIPTION OF THE SEVERAL VIEWS OF THE DRAWING(S)

Further features, advantages and details of the invention will now be explained in more detail with reference to the schematic drawing, which illustrates an exemplary embodiment. In the drawings:

FIG. 1 shows a radial cross section through a pneumatic vehicle tire according to the invention;

FIG. 2 shows a section through a belt bandage ply.

### DETAILED DESCRIPTION

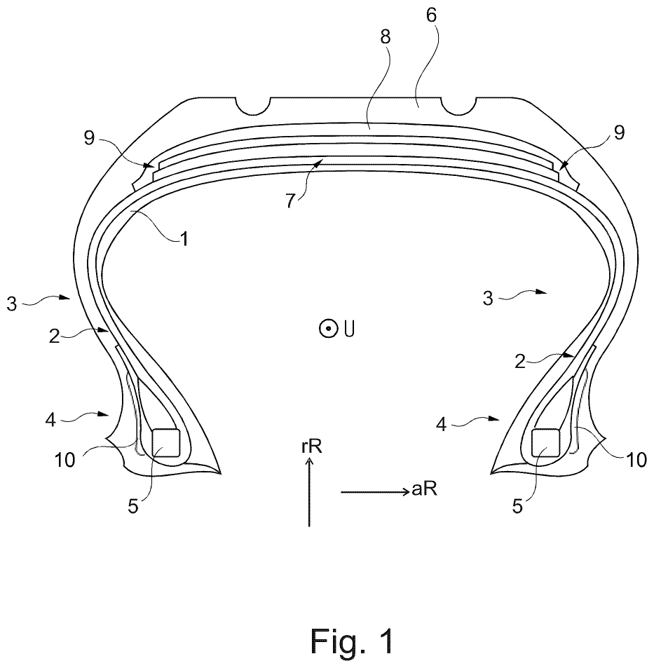

FIG. 1 shows a radial cross section through a pneumatic vehicle tire according to the invention for a passenger car. However, the invention is also suitable for a tire for a light-duty vehicle. The essential components, of which the illustrated pneumatic vehicle tire is composed, are a substantially air-impermeable inner layer 1, a carcass 2, in particular of radial design with textile carcass strength elements, which extends in a conventional manner from the zenith region of the pneumatic vehicle tire over the sidewalls 3 to the bead regions 4 and is anchored there by being looped around tension-resistant bead cores 5. The carcass strength elements can enclose an angle of a maximum of 6° with the radial direction rR of the tire in the region of sidewalls. Furthermore, the pneumatic vehicle tire has a profiled tread 6 located radially outside the carcass 2 and a belt 7 which is arranged between the tread 6 and the carcass 2, in particular contains two strength element plies and is covered radially on the outside by a single- or multi-ply belt bandage 8. The belt bandage 8 covers at least the belt edges 9 and includes at least one belt bandage ply.

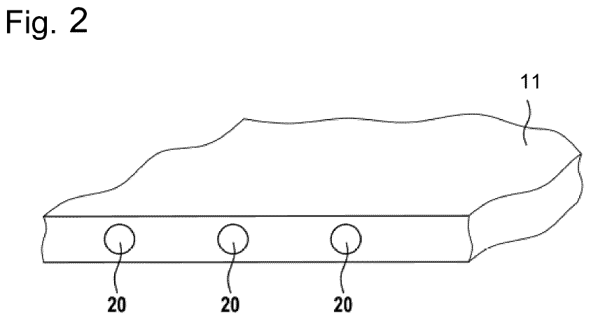

The belt bandage ply has textile cords 20 as strength elements, which are arranged substantially parallel to one another and are embedded in elastomeric material 11, wherein the cords 20 each have precisely two yarns and wherein the two yarns are yarns made of polyamide 6.6 (PA 6.6), which have the same linear density and are end-twisted together to form the cord 20. A section through a corresponding belt bandage ply is illustrated in FIG. 2. The cords 20 are only illustrated schematically. The cords 20 of the belt bandage ply of the belt bandage 8 are arranged, as is customary for strength elements of the belt bandage ply, at an angle between 0° and 5° to the circumferential direction of the tire, in particular are wound or coiled along an axial width of the tire.

The belt bandage 8 may have one, two or more belt bandage plies according to the invention. Preferably, all of the belt bandage plies of the belt bandage 8 of the tire are designed according to the invention. Preferably, at least one cord 20 is arranged over the entire axial extent of the belt 7 and beyond.

The cords 20 at an elongation of 4% have a tangent modulus of 9.3 N/% to 14 N/%, preferably of 9.5 N/% to 13 N/%, particularly preferably of 11 N/% to 12.5 N/%. The tangent modulus of a cord at a given elongation corresponds to the gradient of the force-elongation curve at the respective elongation of the cord, wherein the force-elongation curve is determined according to ASTM D 885/ASTM D 885 M. The force-elongation curve may be determined at the elongated and dipped cord which is provided with an adhesion promoter before being introduced into the elastomeric material.

The belt bandage ply of the belt bandage 8 at 4% elongation of the belt bandage ply in the direction of extent of the cords 20 has a tangent modulus per cm width of the belt bandage ply of 8300 N/cm to 14000 N/cm, preferably of 8500 N/cm to 13000 N/cm.

The cords 20 of the strength elements can have the structure PA 6.6 1880 dtex×2. They can be arranged with a thread density of 80 epdm to 100 epdm, preferably of 85 epdm to 95 epdm, particularly preferably with a thread density of 90 epdm. They can have a twist factor of 120 to 220, preferably 130 to 200, particularly preferably 140 to 180.

### LIST OF REFERENCE SIGNS

### (Part of the Description)

1 Inner layer
2 Carcass
3 Sidewall
4 Bead region
5 Bead core
6 Tread
7 Belt
8 Belt bandage
9 Belt edge
11 Elastomeric material
20 Cord
aR Axial direction
rR Radial direction
U Circumferential direction

1. A pneumatic vehicle tire comprising:
a carcass with a plurality of textile carcass strength elements;
a belt arranged radially outside the carcass; and
a belt bandage ply of a belt bandage arranged radially outside the belt, wherein the belt bandage ply has a plurality of textile cords as strength elements, which are arranged substantially parallel to one another and are embedded in elastomeric material, wherein the cords have precisely two yarns;
wherein the two yarns are yarns of polyamide 6.6, which have the same linear density and are end-twisted together to form the cord (20);
the plurality of textile cords are at an elongation of 4% have a tangent modulus of 9.3 N/% to 14 N/%.

2. The pneumatic vehicle tire of claim 1, wherein the belt bandage ply at 4% elongation of the belt bandage ply in the direction of extent of the cord (20) has a tangent modulus per cm width of the belt bandage ply of 8300 N/cm to 14000 N/cm.

3. The pneumatic vehicle tire of claim 1, wherein the cords have the structure PA 6.6 1880 dtex×2.

4. The pneumatic vehicle tire of claim 1, wherein the cords are arranged with a thread density of 80 epdm to 100 epdm.

5. The pneumatic vehicle tire of claim 1, wherein a twist factor of the plurality of cords is 120 to 220.

6. The pneumatic vehicle tire of claim 1, wherein be plurality of cords have an adhesive impregnation to ensure the adhesion of the cords to the rubber.

7. The pneumatic vehicle tire of claim 1, wherein a cord of the plurality of cords is arranged over the entire axial extent of the belt and beyond.

8. The pneumatic vehicle tire of claim 1, wherein the tire is in a passenger car.

9. The pneumatic vehicle tire of claim 1, wherein the tire is in a light-duty vehicle or a van.

10. A pneumatic vehicle tire comprising:
a carcass;
a plurality of textile carcass strength elements within the carcass;
a belt arranged radially outside the carcass;
a belt bandage;
a belt bandage ply of the belt bandage, the belt bandage ply arranged radially outside the belt;
a plurality of textile cords as strength elements within the belt bandage ply and arranged parallel to one another;
the plurality of textile cords have two yarns of polyamide 6.6, which have the same linear density and are end-twisted together to form the cord;
the plurality of textile cords are at an elongation of 4% have a tangent modulus of 9.3 N/% to 14 N/%; and
the plurality of textile cords are arranged with a thread density of 80 epdm to 100 epdm, have a twist factor of 120 to 220, and an adhesive impregnation.
